(19) United States
(12) Patent Application Publication
(10) Pub. No.: US 2026/0022302 A1
(43) Pub. Date: Jan. 22, 2026

(54) Synthetic Fuel Synthesis

(71) Applicant: Roger X. Lenard, Edgewood, NM (US)

(72) Inventor: Roger X. Lenard, Edgewood, NM (US)

(21) Appl. No.: 19/240,066

(22) Filed: Jun. 17, 2025

Related U.S. Application Data
(62) Division of application No. 18/780,413, filed on Jul. 22, 2024, now abandoned.

(51) Int. Cl. C10L 1/04; B01D 3/14; B01D 5/00; B01J 19/24

(52) U.S. Cl. CPC C10L 1/04; B01D 3/14; B01D 5/006; B01J 19/24; C10L 2200/02; C10L 2200/0277; C10L 2200/0438; C10L 2290/06; C10L 2290/46

(57) ABSTRACT

Methods and systems are disclosed for synthesizing carbon neutral or partially carbon neutral hydrocarbons from sources of carbon such as but not limited to graphite. Carbon, catalyst, heavy oil, and hydrogen are fed into a converter vessel. The converter vessel is heated and pressurized, thereby converting the carbon into a mixed hydrocarbon fuel.

### CROSS-REFERENCE TO RELATED APPLICATIONS

This application claims the benefit of U.S. patent application Ser. No. 18/780,413 filed 22 Jul. 2024, which is incorporated by reference herein in its entirety.

### TECHNICAL FIELD

The present disclosure relates generally to fuel synthesis.

### BACKGROUND OF THE INVENTION

Hydrocarbon sourcing is problematic in our modern world. Much of the supply of fuel comes from underground, but an increasing supply is synthetic.

### SUMMARY OF THE INVENTION

In a first aspect, the disclosure provides a method for synthesizing carbon neutral or partially carbon neutral hydrocarbons. Carbon, catalyst, heavy oil, and hydrogen are fed into a converter vessel. The converter vessel is heated and pressurized, thereby converting the carbon into a mixed hydrocarbon fuel.

In a second aspect, the disclosure provides a system for synthesizing fuel. A converter vessel is configured to receive carbon, catalyst, heavy oil, and hydrogen. The converter vessel is further configured to heat and pressurize the carbon, catalyst, heavy oil, and hydrogen, thereby converting the carbon into a mixed hydrocarbon fuel.

Further aspects and embodiments are provided in the foregoing drawings, detailed description and claims.

### BRIEF DESCRIPTION OF DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a block diagram showing a method for synthesizing carbon neutral or partially carbon neutral hydrocarbons.

FIG. 2 is a block diagram showing a method for synthesizing carbon neutral or partially carbon neutral hydrocarbons.

FIG. 3 is a process flow diagram showing a system for synthesizing carbon neutral or partially carbon neutral hydrocarbons.

FIG. 4 is a process flow diagram showing a system for synthesizing carbon neutral or partially carbon neutral hydrocarbons.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “carbon neutral” is meant to refer to production of a fuel that is obtained by absorbing carbon from carbon dioxide in the environment. Carbon neutrality is achieved through generating a balance between emitting carbon and absorbing carbon from the atmosphere in carbon sinks. There are natural carbon sinks, such as plants and the ocean. Removing carbon dioxide from the atmosphere and then storing it either as elemental carbon or as CO2 is known as carbon sequestration. Sequestration can be achieved either by chemically or thermochemically reducing CO2 to elemental carbon and oxygen or pumping CO2 into subterranean vaults. Chemical reduction to elemental carbon and oxygen is deemed superior to pumping gaseous CO₂ into subterranean vaults, because the CO2 may leak out over time. The present invention is designed to use a source of CO2 which has been extracted from the atmosphere. That generates a reduction in the atmosphere's CO2 content. Using the resulting elemental carbon to produce jet fuel and similar, then consuming the fuel, returns the CO2 back into the atmosphere. However, as the total number of carbon atoms are conserved as they are turned into CO2, the result is no net increase in CO2. In order to achieve net zero emissions, all worldwide greenhouse gas (GHG) emissions will have to be counterbalanced by carbon sequestration, resulting in a carbon neutral world.

As used herein, “carbon” is used to refer to graphite, carbon black, or other allotropes of carbon.

In the present invention, using feedstocks of varying amounts of carbon (chemically or thermochemically), reduced from CO2 or carbon obtained from methane pyrolysis and hydrogen in a high-temperature, high-pressure environment, synthetic fuel can be produced which is either 100% carbon neutral, 0% carbon neutral, or any fractional carbon neutrality in between. The process utilizes a modified Bergius process. The present invention does not use Bituminous coal as the carbon source, and therefore is capable of producing carbon neutral fuel. Further, without coal, there is no need for coal crushing, denitrogenization, or sulfur removal. The process as described below may use elemental carbon or graphite (herein, elemental carbon is lumped under the term ‘carbon’) from either methane pyrolysis or reduction of CO2. As such, graphite so obtained has little to no contaminants. The products are typically nanoparticle carbon or carbon black. On one extreme, fully carbon neutral carbon is referred to herein as ‘green’ carbon. Graphite without carbon neutrality is ‘black’ graphite. These terms do not reflect the actual spectral color of the carbon. There is a large supply of both green and black carbon available due to manufacturing surpluses or from CO₂ sequestration processes. As such, these become a useful feedstock for making carbon neutral fuel.

Catalysts used may be of nickel or zinc oleates or other appropriate catalysts.

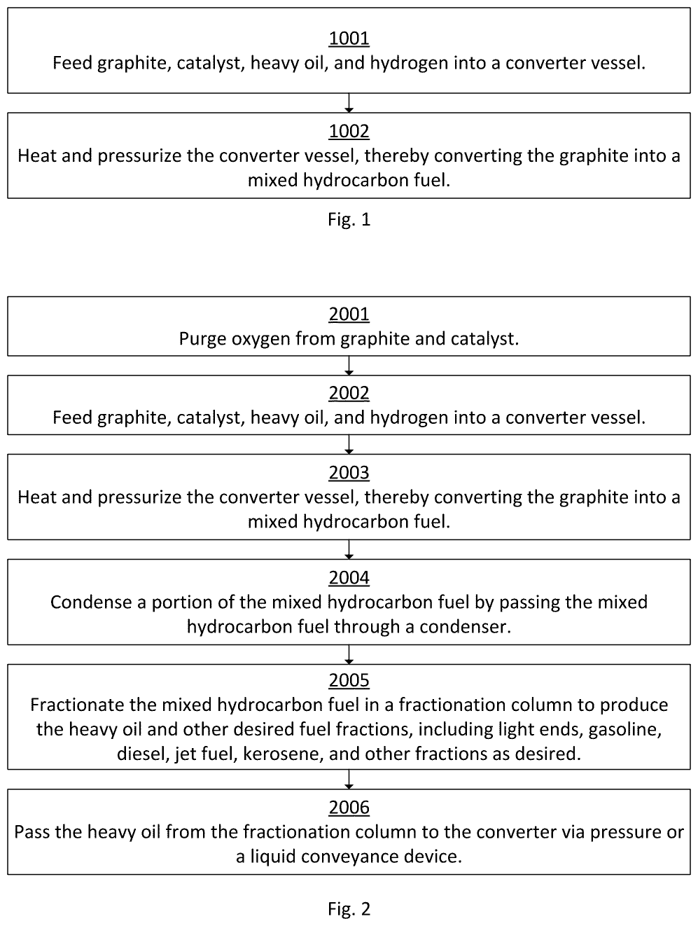

Now referring to the Figures, FIG. 1 is a block diagram showing a method for synthesizing carbon neutral or partially carbon neutral hydrocarbons that may be used in one embodiment of the present invention. At 1001, carbon, catalyst, heavy oil, and hydrogen are fed into a converter vessel. At 1002, the converter vessel is heated and pressurized, thereby converting the carbon into a mixed hydrocarbon fuel. In some embodiments, the blend of heavy oil is varied. In some embodiments, the amount of heavy oil used is zero.

FIG. 2 is a block diagram showing a method for synthesizing carbon neutral or partially carbon neutral hydrocarbons that may be used in one embodiment of the present invention. At 2001, the carbon and catalyst are purged of oxygen. This can be by passing nitrogen through their storage container, through their conveyance system, or by other standard means of purging oxygen from solids. At 2002, graphite, catalyst, heavy oil, and hydrogen are fed into a converter vessel. At 2003, the converter vessel is heated and pressurized, thereby converting the graphite into a mixed hydrocarbon fuel. At 2004, a portion of the mixed hydrocarbon fuel is condensed by massing the mixed hydrocarbon fuel through a condenser. At 2005, the mixed hydrocarbon fuel is fractionated in a fractionation column to produce the heavy oil and other desired fuel fractions. These include but are not limited to light ends, gasoline, diesel, jet fuel, and kerosene. Light ends include hydrocarbons such as methane, ethane, propane, and similar. At 2006, the heavy oil is passed from the fractionation column to the converter. This can be by pressure or by a liquid conveyance device, such as a pump. Gravity can also be used where appropriate.

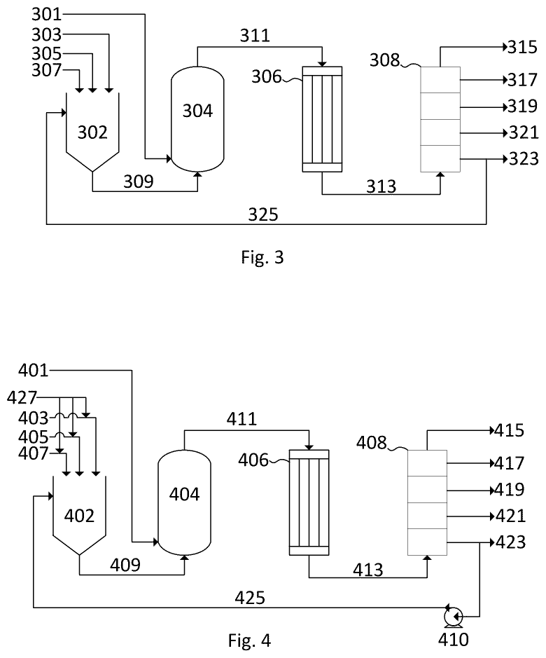

FIG. 3 is a process flow diagram showing a system for synthesizing carbon neutral or partially carbon neutral hydrocarbons that may be used in one embodiment of the present invention. The process flow diagram is at a level of detail appropriate for this discussion and does not include details that would be apparent to one of ordinary skill in the art, such as valves and instruments. A hopper 302 receives catalyst 303, green carbon 305, and black carbon 307. The ratio of green to black carbon determines how carbon neutral the final product is. Use of only green carbon makes the final product essentially carbon neutral, as far as feedstock is concerned. Use of black carbon reduces how carbon neutral the final products are. In one embodiment, only green carbon is used, producing carbon neutral hydrocarbons. The mixture has heavy oil 325 added and the combination is conveyed to converter vessel 304. Hydrogen gas stream 301 is added to converter vessel 304 and the converter vessel 304 is heated and pressurized to a temperature between 400 and 500C and a pressure between 200 and 250 atmospheres. At this temperature and pressure, the converter vessel 304 converts the graphite stream to a mixed hydrocarbon fuel stream 311, consuming the hydrogen stream 301. The mixed hydrocarbon fuel stream 311 is passed through a condenser 306 to produce a combination of liquids and gases in stream 313. These are passed through a fractionation column 308, splitting the stream into at least light ends 315, gasoline 317, diesel 319, jet fuel 321, and heavy oil 323. The exact split is dependent on the fractionation column 308 and the exact process conditions chosen in the converter vessel 304. A person of normal skill in the art can fine tune the exact blend of product produced. At least a portion of the heavy oil is sent as heavy oil stream 325 as a recycle. This recycle stream keeps the conversion process properly balanced and the ratios are decided to maintain optimal conversion based on product needs.

FIG. 4 is a process flow diagram showing a system for synthesizing carbon neutral or partially carbon neutral hydrocarbons that may be used in one embodiment of the present invention. Nitrogen or another inert gas 427 is used to purge oxygen from catalyst 403, green carbon 405, and black carbon 407. A hopper 402 receives catalyst 403, green carbon 405, and black carbon 407. The ratio of green to black carbon determines how carbon neutral the final product is. Use of only green carbon e makes the final product essentially carbon neutral, as far as feedstock is concerned. Use of black carbon reduces how carbon neutral the final products are. In one embodiment, only green carbon e is used, producing carbon neutral hydrocarbons. The mixture has heavy oil 425 added and the combination is conveyed to converter vessel 404. Hydrogen gas stream 401 is added to converter vessel 404 and the converter vessel 404 is heated and pressurized to a temperature between 400 and 500C and a pressure between 200 and 250 atmospheres. At this temperature and pressure, the converter vessel 404 converts the graphite stream to a mixed hydrocarbon fuel stream 411, consuming the hydrogen stream 401. The mixed hydrocarbon fuel stream 411 is passed through a condenser 406 to produce a combination of liquids and gases in stream 413. These are passed through a fractionation column 408, splitting the stream into at least light ends 415, gasoline 417, diesel 419, jet fuel 421, and heavy oil 423. The exact split is dependent on the fractionation column 408 and the exact process conditions chosen in the converter vessel 404. A person of normal skill in the art can fine tune the exact blend of product produced. At least a portion of the heavy oil is sent as heavy oil stream 425 as a recycle via pump 410. This recycle stream keeps the conversion process properly balanced and the ratios are decided to maintain optimal conversion based on product needs.

The invention has been described with reference to various specific and preferred embodiments and techniques. Nevertheless, it is understood that many variations and modifications may be made while remaining within the spirit and scope of the invention.

1. A method for synthesizing carbon neutral or partially carbon neutral hydrocarbons comprising:
mixing nanoparticle carbon, catalyst, heavy oil, and hydrogen in a converter vessel; and
heating and pressurizing the converter vessel, thereby converting the carbon into a mixed hydrocarbon fuel.

2. The method of claim 1, further comprising condensing a portion of the mixed hydrocarbon fuel by passing the mixed hydrocarbon fuel through a condenser.

3. The method of claim 2, further comprising fractionating the mixed hydrocarbon fuel in a fractionation column to produce the heavy oil and other desired fuel fractions.

4. The method of claim 3, wherein the other desired fuel fractions comprise light ends, gasoline, diesel, jet fuel, and kerosene.

5. The method of claim 3, further comprising passing the heavy oil from the fractionation column to the converter vessel via pressure or a liquid conveyance device.

6. The method of claim 1, wherein the nanoparticle carbon is at least partially carbon neutral.

7. The method of claim 1, wherein the converter operates from 400 to 500 C and between 200 and 250 atmospheres.

8. The method of claim 1, wherein the nanoparticle carbon and catalyst are purged of oxygen before addition to the converter vessel.
